(19) United States
(12) Patent Application Publication
(10) Pub. No.: US 2010/0276826 A1
(43) Pub. Date: Nov. 4, 2010

(54) PROCESS FOR PRODUCING RETARDATION FILM

(76) Inventors: Hiroaki Takahata, Ichihara-shi (JP); Yoshinori Takahashi, Ichihara-shi (JP); Kyoko Hino, Nerima-ku (JP)

Correspondence Address: SUGHRUE MION, PLLC, 2100 PENNSYLVANIA AVENUE, N.W., SUITE 800, WASHINGTON, DC, 20037, US

(21) Appl. No.: 12/679,285

(22) PCT Filed: Sep. 17, 2008
(86) PCT No.: PCT/JP2008/066779

§ 371 Date: May 19, 2010

(30) Foreign Application Priority Data
Sep. 21, 2007 (JP) 2007-245689

(51) Int. Cl. B29D 11/00

(52) U.S. Cl. 264/2.7

(57) ABSTRACT

A method for producing a retardation film by a tenter method, in which a thermoplastic resin film 20 is stretched in the width direction thereof while heating the film with hot air supplied from blowout ports of a plurality of nozzles 30, 32 provided on the upper and lower portions of an oven 100, having a preheating step of heating the thermoplastic resin film 20 with hot air; a stretching step of stretching the thermoplastic resin film 20 preheated while heating it with hot air to obtain a stretched film 22; and a heat setting step of heating the stretched film 22 with hot air, in which, in the preheating step, the stretching step and/or the heat setting step, an air blow velocity at the blowout port of hot air to be used is 2 to 12 m/second and air blow amount per nozzle is 0.1 to 1 m³/second per meter of the length of the nozzle along the width direction of the film.

### TECHNICAL FIELD

The present invention relates to a process for producing a retardation film.

### BACKGROUND ART

In a display section of a liquid crystal display device, a liquid crystal and a retardation film are used in combination. To describe more specifically, in the display section of a liquid crystal display device a pair of retardation films are laminated so as to sandwich a liquid crystal cell and a polarizing film and a protecting film are laminated outside the laminate.

The retardation film, which is used in combination with a liquid crystal cell, has a function of forming phase difference due to difference in refractive index, thereby improving the view angle of a liquid crystal display device.

The retardation film can be obtained by stretching a resin material molded in a film form. As a resin material for a retardation film, a polyolefin resin has been proposed (see Patent Document 1, for example). However, as a retardation film that can satisfy optical performance required for a liquid crystal device, films formed of polycarbonate resins and films formed of cyclic olefin based polymer resins have been proposed (see Patent Document 2 and Patent Document 3, for example).

### Patent Document 1: Japanese Patent Publication No. 53-11228

### Patent Document 2: Japanese Patent Application Laid-Open No. 07-256749

### Patent Document 3: Japanese Patent Application Laid-Open No. 05-2108

### DISCLOSURE OF THE INVENTION

### Problems to be Solved by the Invention

However, polycarbonate resins and cyclic olefin based polymer resins are expensive. Thus, it is desired to form a retardation film by using a general-purpose resin material lower in cost as a raw material.

However, in a retardation film formed by biaxially stretching in accordance with a conventional tenter method as disclosed in Patent Document 1, the orientation is not uniform, phase difference varies and thickness varies in the film-width direction. Therefore, the film lacks sufficient performance as a retardation film.

The present invention was made in the aforementioned circumstances and intends to provide a method for producing a thermoplastic resin retardation film having sufficiently uniform phase difference and sufficiently high axis accuracy.

### Means for Solving the Problems

To attain the aforementioned object, the present invention provides a method for producing a retardation film by a tenter method, having a preheating step of heating a thermoplastic resin film with hot air; a stretching step of stretching the preheated thermoplastic resin film in the width direction while heating it with hot air to obtain a stretched film; and a heat setting step of heating the stretched film with hot air, in which the heating of a film in at least one step selected from the group consisting of the preheating step, the stretching step and the heat setting step is performed by spraying hot air supplied from blowout ports of a pair of nozzles facing each other to both surfaces of the film; an air blow velocity at the blowout port is 2 to 12 m/second, an air blow amount from the blowout port per nozzle is 0.1 to 1 m³/second per meter of the length of the nozzle along the width direction of the film.

In the method for producing a retardation film, the heating of a film in at least one step of the preheating step, the stretching step and the heat setting step is performed with hot air whose blow velocity and blow amount fall within prescribed ranges. By virtue of this, the film (thermoplastic resin film and/or stretched film) can be uniformly heated to obtain a retardation film excellent in orientation. In addition, since the fluttering of the film is inhibited, a retardation film can be obtained with thickness variation and defect sufficiently reduced. Since such a retardation film has sufficiently uniform phase difference and has sufficiently high axis accuracy, it is sufficiently excellent in optical homogeneity. The amount of air (m³/second) from the blowout port (m³/second) per nozzle can be obtained by multiplying an air blow velocity (m/second) by the area (m²) of the blowout port. When the air blow amount is divided by the length of the film along the width direction, the air blow amount (m³/second) per meter of the length of each nozzle along the width direction can be obtained.

In the present invention, the nozzle is preferably a jet nozzle having a slit-form blowout port extending in the width direction of the film or a punching nozzle having a blowout port having a plurality of openings arranged in the longitudinal direction of the film and in the width direction of the film.

By virtue of using a jet nozzle or a punching nozzle as described, the film can be heated further more uniformly. As a result, a retardation film having more uniform phase difference and further higher axis accuracy can be obtained.

In the present invention, it is preferred that the nozzle is a jet nozzle having a slit-form blowout port extending in the width direction of the film and that a slit width of the jet nozzle is 5 mm or more.

When such a jet nozzle having a slit width as specified above is used, the area of a hot-air blowout port is increased, with the result that the blow velocity of hot air can be sufficiently reduced. Hence, it is possible to heat the film further more uniformly to obtain a retardation film having further more uniform phase difference and further higher axis accuracy.

In the present invention, the interval between the pair of nozzles facing each other is preferably 150 mm or more. By virtue of the nozzles arranged in this way, fluttering of the film in each step can be further inhibited without fail. As a result, a retardation film whose thickness variation and defect are further sufficiently reduced can be obtained.

In the present invention, in at least one step selected from the group consisting of the preheating step, the stretching step and the heat setting step, the difference between a maximum temperature and a minimum temperature of hot air, in the film-width direction, at a blowout port of the nozzle for spraying hot air to the film is preferably 2° C. or less. Furthermore, the difference between the maximum temperature and the minimum temperature is more preferably 1° C. or less.

By use of hot air having a sufficiently low temperature difference in the width direction as mentioned above, variation of orientation in the width direction is suppressed. As a result, a retardation film having further more uniform phase difference and further higher axis accuracy can be obtained.

In the present invention, in at least one step selected from the group consisting of the preheating step, the stretching step and the heat setting step, the difference between a maximum blow velocity and a minimum blow velocity of hot air in the width direction of the film at the blowout port of each nozzle for spraying the hot air to the film is preferably 4 m/s or less. Furthermore, the difference between the maximum air blow velocity and the minimum air blow velocity is more preferably 2 m/s or less, and further preferably 1 m/s or less.

By use of the hot air as mentioned above, the film can be further more uniformly heated in each step. Therefore, a retardation film having further more uniform phase difference and further higher axis accuracy can be obtained.

In the present invention, all of the preheating step, the stretching step and the heat setting step are preferably performed in an oven having a cleanliness factor of an air cleanliness class of 1000 or less.

By heating the film in an oven having a high cleanliness factor as mentioned above, the occurrence of defect in the resultant retardation film can be more sufficiently inhibited.

In the present invention, the thermoplastic resin is preferably a crystalline polyolefin based resin. By use of the polyolefin based resin, a retardation film excellent in recycling efficiency and solvent resistance can be obtained.

In the present invention, the crystalline polyolefin based resin is preferably a polypropylene based resin. By use of the polypropylene based resin, a retardation film excellent in heat resistance can be obtained.

In the retardation film obtained in the aforementioned production method, phase difference derived from optical inhomogeneity and variation of an optical axis can be sufficiently reduced. Therefore, the retardation film can express excellent view-angle characteristics when used in a liquid crystal display device.

### EFFECT OF THE INVENTION

According to the present invention, it is possible to provide a method for producing a thermoplastic resin retardation film having sufficiently uniform phase difference, sufficiently high axis accuracy and excellent optical homogeneity.

### BRIEF DESCRIPTION OF THE DRAWINGS

FIG. 1 is a schematic view showing a step of a method for producing a retardation film according to a preferable embodiment of the present invention.

FIG. 2 is a schematic sectional view showing a step of a method for producing a retardation film according to a preferable embodiment of the present invention.

FIG. 3 is a schematic sectional view showing an exemplary shape of a jet nozzle preferably used in a method for producing a retardation film of the present invention.

FIG. 4 is a schematic sectional view showing an exemplary shape of a punching nozzle preferably used in a method for producing a retardation film of the present invention.

FIG. 5 is a schematic sectional view showing another exemplary shape of a punching nozzle preferably used in a method for producing a retardation film of the present invention.

### DESCRIPTION OF SYMBOLS

10 . . . preheating zone, 12 . . . stretching zone, 14 . . . heat setting zone, 18 . . . chuck, 20 . . . raw-material film (thermoplastic resin film), 22 . . . stretched film, 25 . . . film, 30 . . . upper nozzle (nozzle), 32 . . . lower nozzle (nozzle), 34 . . . jet nozzle, 36, 38 . . . punching nozzle, 36a, 38a . . . surface, 40 . . . slit, 42, 44 . . . opening, 100 . . . oven, 100a . . . upper surface, 100b . . . lower surface.

### BEST MODES FOR CARRYING OUT THE INVENTION

Preferable embodiments of the present invention will be described below, if necessary, with reference to the drawings. In the description about the drawings, like reference symbols are used for designating like or equivalent structural elements and any further explanation is omitted for brevity's sake.

The method for producing a retardation film of this embodiment is a production method by a tenter method in which a raw-material film formed of a thermoplastic resin is stretched in the width direction while spraying hot air from a plurality of nozzles, which is provided in the upper and lower portions of an oven so as to face each other.

According to this embodiment, the stretching in the width direction (transverse stretching) is performed by a tenter method. The tenter method is a method of transversely stretching a film by fixing the film at both ends in the width direction by a plurality of chucks arranged so as to face each other in the film-width direction and gradually increasing the distance between the chucks facing each other in an oven.

A precursor film formed of a general thermoplastic resin can be used as the raw-material film in the method for producing a retardation film according to this embodiment. First, the thermoplastic resin will be more specifically described below.

<Thermoplastic Resin>

Examples of the thermoplastic resin include a homopolymer of an olefin such as ethylene, propylene, butene, hexene and cyclic olefin or a copolymer of two or more types of olefins; a polyolefin based resin, which is a copolymer of at least one type of olefin and at least one type of monomer polymerizable with the olefin; an acrylic based resin such as polymethyl acrylate, polymethyl methacrylate and an ethylene-ethylacrylate copolymer; a styrene based resin such as a butadiene-styrene copolymer, an acrylonitrile-styrene copolymer, polystyrene, a styrene-butadiene-styrene copolymer, a styrene-isoprene-styrene copolymer and a styrene-acrylic acid copolymer; vinyl chloride based resin; a vinyl fluoride based resin such as polyvinyl fluoride and polyvinylidene fluoride; an amide based resin such as 6-nylon, 6,6-nylon and 12-nylon; a saturated ester based resin such as polyethylene terephthalate and polybutylene terephthalate; polycarbonate, polyphenylene oxide, polyacetal, polyphenylene sulfide, a silicone resin, a thermoplastic urethane resin, polyetheretherketone, polyetherimide, polyacrylonitrile, a cellulose derivative, polysulfone, polyethersulfone, various types of thermoplastic elastomers and crosslinked products and modified products of these. These thermoplastic resins may be used by blending two or more different types or may contain an additive.

Of the thermoplastic resins mentioned above, a polyolefin based resin can be preferably used, because it has excellent recycle efficiency and solvent resistance. In addition, even if incinerated, it does not produce dioxin or the like that undermines the environment.

As the olefin constituting the polyolefin based resin, ethylene, propylene, α-olefin having 4 to 20 carbon atoms and cyclic olefin, for example, are preferable.

Specific examples of the α-olefin having 4 to 20 carbon atoms include 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 2,3-dimethyl-1-pentene, 3-methyl-1-pentene, 4-methyl-1-pentene, 3,3-dimethyl-1-butene, 1-heptene, 2-methyl-1-hexene, 2,3-dimethyl-1-pentene, 2-ethyl-1-pentene, 2-methyl-3-ethyl-1-butene, 1-octene, 2-ethyl-1-hexene, 3,3-dimethyl-1-hexene, 2-propyl-1-heptene, 2-methyl-3-ethyl-1-heptene, 2,3,4-trimethyl-1-pentene, 2-propyl-1-pentene, 2,3-diethyl-1-butene, 1-nonene, 1-decene, 1-undecene, 1-dodecene, 1-tridecene, 1-tetradecene, 1-pentadecene, 1-hexadecene, 1-heptadecene, 1-octadecene and 1-nonadecene.

Examples of the cyclic olefin include bicyclo[2.2.1]hept-2-ene generally called norbornene; a norbornene derivative (in which an alkyl group having 1 to 4 carbon atoms such as a methyl group, an ethyl group and a butyl group is introduced) such as 6-alkylbicyclo[2.2.1]hept-2-ene, 5,6-dialkylbicyclo[2.2.1]hept-2-ene, 1-alkylbicyclo[2.2.1]hept-2-ene and 7-alkylbicyclo[2.2.1]hept-2-ene; tetracyclo[4.4.0.1^{2,5}.1^{7,10}]-3-dodecene also called a dimethanooctahydro naphthalene; a dimethanooctahydronaphthalene derivative (in which an alkyl group having not less than 3 carbon atoms is introduced into the 8-position and/or the 9-position of dimethanooctahydro naphthalene) such as 8-alkyltetracyclo[4.4.0.1^{2,5}.1^{7,10}]-3-dodecene and 8,9-dialkyltetracyclo[4.4.0.1^{2,5}.1^{7,10}]-3-dodecene; a norbornene derivative having a single or plurality of halogens introduced in a single molecule; and a dimethanooctahydronaphthalene derivative having a halogen(s) introduced into the 8-position and/or the 9-position.

Examples of the “at least one type of polymerizable monomer with an olefin” mentioned above include an aromatic vinyl compound, an alicyclic vinyl compound such as vinylcyclohexene, a polar vinyl compound and a polyene compound.

As the aromatic vinyl compound, styrene and a derivative thereof, for example, are mentioned. Example of the styrene derivative, which is a compound formed of styrene and a substituent (other than styrene) bound thereto, include an alkyl styrene such as o-methylstyrene, m-methylstyrene, p-methylstyrene, 2,4-dimethylstyrene, o-ethyl styrene and p-ethyl styrene; a substituted styrene (which is a styrene having a substituent, such as a hydroxy group, an alkoxy group, a carboxyl group, an acyloxy group and a halogen, introduced in a benzene ring thereof) such as hydroxystyrene, t-butoxystyrene, vinyl benzoate, vinylbenzyl acetate, o-chlorostyrene and p-chlorostyrene; a vinylbiphenyl based compound such as 4-vinylbiphenyl and 4-hydroxy-4′-vinylbiphenyl;

a vinylnaphthalene based compound such as 1-vinylnaphthalene and 2-vinylnaphthalene; a vinylanthracene compound such as 1-vinylanthracene and 2-vinylanthracene; a vinylpyridine compound such as 2-vinylpyridine and 3-vinylpyridine; a vinyl carbazole compound such as 3-vinyl carbazole; and an acenaphthylene compound.

Examples of the polar vinyl compound include an acrylic compound such as methylacrylate, methyl methacrylate and ethyl acrylate, vinyl acetate and vinyl chloride.

Examples of the polyene compound include a conjugated polyene compound and a non-conjugated polyene compound. Examples of the conjugated polyene compound include an aliphatic conjugated polyene compound and an alicyclic conjugated polyene compound. Examples of the non-conjugated polyene compound include an aliphatic non-conjugated polyene compound, an alicyclic non-conjugated polyene compound and an aromatic non-conjugated polyene compound. These may have a substituent such as an alkoxy group, an aryl group, an aryloxy group, an aralkyl group and an aralkyloxy group.

Specific examples of the polyolefin based resin include a polyethylene based resin such as a low-density polyethylene, a linear polyethylene (copolymer of ethylene and α-olefin) and a high-density polyethylene; a polypropylene based resin such as polypropylene, a propylene-ethylene copolymer and a copolymer of propylene and 1-butene; an ethylene-cyclic olefin copolymer, an ethylene-vinylcyclohexane copolymer, poly(4-methylpentene-1), poly(butene-1), an ethylene-methyl acrylate copolymer, an ethylene-methyl methacrylate copolymer, an ethylene-ethyl acrylate copolymer and an ethylene-vinyl acetate copolymer.

Examples of the modified polyolefin based resin include a crystalline polyolefin based resin modified with a modification compound such as maleic anhydride, dimethyl maleate, diethyl maleate, acrylic acid, methacrylic acid, tetrahydrophthalic acid, glycidyl methacrylate and hydroxyethyl methacrylate.

In the specification, the crystalline polyolefin based resin refers to one of the polyolefin based resins mentioned above and having a crystal melting peak having a heat capacity of larger than 1 J/g or a crystallization peak having a crystallization heat capacity of larger than 1 J/g or more, each being observed in the range of −100 to 300° C. in differential scanning calorimetry in accordance with JIS K 7122.

In view of obtaining a retardation film having good appearance, it is preferred to use a raw-material film formed of a crystallization polyolefin based resin, which has a crystal melting peak having a heat capacity larger than 30 J/g or a crystallization peak having a crystallization heat larger than 30 J/g or more each being observed in the range of −100 to 300° C.

The crystalline polyolefin based resin may be a blend of not less than two types of different crystalline polyolefin based resins or may contain a resin other than the crystalline polyolefin based resin and an additive.

Of the polyolefin based resins, a polypropylene based resin is more preferable. Examples of the polypropylene based resin include a propylene homopolymer, a copolymer of at least one type of monomer selected from ethylene and an α-olefin having 4 to 20 carbon atoms and propylene, and a mixture of the singe polymer and the copolymer.

Examples of the α-olefin include α-olefins having 4 to 20 carbon atoms, which are provided as examples above as the olefin constituting the olefin based resin.

Of the aforementioned α-olefins, an α-olefin having 4 to 12 carbon atoms is preferred. Specifically, preferable examples thereof include 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, 2-methyl-1-hexene, 2,3-dimethyl-1-pentene, 2-ethyl-1-pentene, 2,3,4-trimethyl-1-butene, 2-methyl-3-ethyl-1-butene, 1-octene, 5-methyl-1-pentene, 2-ethyl-1-hexene, 3,3-dimethyl-1-hexene, 2-propyl-1-heptene, 2-methyl-3-ethyl-1-heptene, 2,3,4-trimethyl-1-pentene, 2-propyl-1-pentene, 2,3-diethyl-1-butene, 1-nonene, 1-decene, 1-undecene and 1-dodecene.

Of the α-olefins having 4 to 12 carbon atoms, in view of co-polymerizability, 1-butene, 1-pentene, 1-hexene and 1-octene are more preferable, and 1-butene and 1-hexene are further preferable.

In view of further improving the effect of the invention, a propylene homopolymer, a copolymer of propylene and ethylene, a copolymer of propylene and 1-butene, a copolymer of propylene and 1-pentene, a copolymer of propylene and 1-hexene, a copolymer of propylene and 1-octene, a copolymer of propylene, ethylene and 1-butene, a copolymer of propylene, ethylene and 1-hexene and a copolymer of propylene, ethylene and 1-octene are particularly preferable. Furthermore, when a polypropylene based resin according to this embodiment is a copolymer of at least one monomer selected from the group consisting of ethylene and an α-olefin having 4 to 20 carbon atoms and propylene, the copolymer may be a random copolymer or a block copolymer.

In this embodiment, when a polypropylene based resin is a copolymer of at least one monomer (comonomer) selected from the group consisting of ethylene and an α-olefin having 4 to 20 carbon atoms and propylene, the content of a constitutional unit derived from the comonomer of the copolymer is preferably more than 0% by mass and not more than 40% by mass, and more preferably more than 0% by mass and not more than 30% by mass in view of balance between transparency and heat resistance. The polypropylene based resin is a copolymer of not less than two types of comonomers and propylene, the total content of constitutional units derived from all comonomers contained in the copolymer preferably falls within the aforementioned range.

Examples of the method for producing a polypropylene based resin include a method for polymerizing propylene alone using a known polymerization catalyst and a method for copolymerizing at least one type of monomer selected from ethylene and α-olefin having 4 to 20 carbon atoms and propylene.

Examples of the polymerization catalyst to be used in the method for producing a polypropylene based resin include

(1) a Ti—Mg based catalyst made of e.g., a solid catalyst component essentially containing magnesium, titanium and halogen;
(2) a catalyst made of a solid catalyst component essentially containing magnesium, titanium and halogen in combination with an organic aluminum compound, and if necessary, a third component such as an electron-donating compound; and
(3) a metallocene catalyst.

Of the aforementioned polymerization catalysts, a catalyst made of a solid catalyst component essentially containing magnesium, titanium and halogen in combination with an organic aluminum compound and an electron-donating compound can be most generally used. More specifically, as the organic aluminum compound, triethylaluminum, triisobutylaluminum, a mixture of triethylaluminum and diethylaluminium chloride and tetraethyldialuminoxane can be preferably used. As the electron-donating compound, cyclohexyl ethyl dimethoxy silane, tert-butyl-n-propyl dimethoxy silane, tert-butyl ethyl dimethoxy silane and dicyclopentyl dimethoxy silane can be preferably used.

As the solid catalyst component essentially containing magnesium, titanium and halogen, for example, catalysts described, for example, in Japanese Patent Application Laid-Open Nos. 61-218606, 61-287904 and 7-216017 are included. As the metallocene catalyst, catalysts described, for example, in Japanese Patent Nos. 2587251, 2627669 and 2668732 are included.

As a method for polymerizing a polypropylene based resin, a solvent polymerization method using an inert solvent represented by a hydrocarbon compound such as hexane, heptane, octane, decane, cyclohexane, methylcyclohexane, benzene, toluene and xylene; a bulk polymerization method using a liquid state monomer as a solvent; and a vapor phase polymerization method performed in a gaseous monomer are included. Of them, the bulk polymerization method or the vapor-phase polymerization method is preferable. These polymerization methods may be performed in a batch process or a continuous process.

As the stereoregularity of a polypropylene based resin, any one of isotactic, syndiotactic and atactic may be used. In view of heat resistance, the polypropylene based resin is preferably a syndiotactic or isotactic propylene based polymer.

The polypropylene based resin may be a blend of not less than two types of polypropylene based resins mutually different in molecular weight, ratio of a constitutional unit derived from propylene and tacticity and may contain a polymer other than a polypropylene based resin and an additive.

The thermoplastic resin to be used in the present invention may contain a known additive as long as the effect of the invention can be obtained. Examples of the additive include an antioxidant, a UV ray absorbent, an antistatic agent, a lubricant, a nucleating agent, an anticlouding agent and an antiblocking agent.

Examples of the antioxidant include a phenol based antioxidant, a phosphorus based antioxidant, a sulfur based antioxidant, a hindered amine based antioxidant (HALS) and a complex-type antioxidant, which has a unit having a phenol based antioxidation mechanism and a phosphorus based antioxidation mechanism in a single molecule.

Examples of the UV ray absorbent include a UV ray absorbent such as a 2-hydroxy benzophenone based absorbent and a hydroxy triazole based absorbent and a UV ray blocking agent such as a benzoate based blocking agent.

Examples of the antistatic agent include a polymer antistatic agent, an oligomer antistatic agent and a monomer antistatic agent. Examples of the lubricant include a higher fatty acid amide such as erucamide and oleic amide, a higher fatty acid such as stearic acid and a metal salt thereof.

Examples of the nucleating agent include a sorbitol based nucleating agent, an organic phosphate based nucleating agent and a polymer nucleating agent such as polyvinyl cycloalkane. As the antiblocking agent, inorganic based and organic based microparticles of spherical shape or nearly spherical shape can be used. The aforementioned additives can be used singly or in combination with two or more types.

In this embodiment, the melt flow rate (hereinafter, referred to as “MFR” for convenience sake) of a thermoplastic resin can be measured in accordance with JIS K7210. In the measurement, the test temperature and nominal load can be selected in accordance with the attachment B (Table 1) of JIS K7210. In this embodiment, MFR of a thermoplastic resin is generally 0.1 to 50 g/10 minutes, preferably 0.5 to 20 g/10 minutes. If a thermoplastic resin having an MFR within the range is used, a uniform film-form material can be molded without applying any large load on an extruder. In the case of a polypropylene based resin, an MFR can be measured at a test temperature of 230° C. and a load of 21.18 N.

Next, a thermoplastic resin film, that is, a raw-material film, to be used in this embodiment will be more specifically described. As the raw-material film, that is, a precursor film, used in this embodiment, a film formed of a general thermoplastic resin can be used. The precursor film to be used as a raw-material film is preferably optically homogeneous film having no orientation or almost no orientation. More specifically, a precursor film having an in-plane phase difference (R₀) of 30 nm or less is preferably used. Such a precursor film can be produced by a solvent casting method and an extrusion molding method.

In the solvent casting method, a film formed on a substrate by casting a solution having a thermoplastic resin dissolved in an organic solvent by means of a die coater onto a substrate such as a biaxially stretched polyester film having releasability, and then drying the film to remove the organic solvent. The film formed on the substrate by such a method can be removed from the substrate and used as a precursor film.

In the extrusion molding method, a film is obtained by melting and kneading a thermoplastic resin in an extruder and extruding it from a T-shaped die, and taking up the film while bringing the extruded film into contact with a roll to thereby solidify and cooling. The polypropylene based resin film formed by this method can be directly used as a raw-material film. In view of manufacturing cost of the precursor film, the extrusion molding method is more preferable than the solvent casting method.

When the precursor film is formed by the extrusion molding method using a T-shaped die as described above, a molten material extruded from the T-shaped die is cooled and solidified by the following methods: a method (1) of cooling the material using a casting roll and an air chamber, a method (2) of nipping the material between a casting roll and a touch roll and pressurizing it, a method (3) of nipping the material between a casting roll and a metallic endless belt, which is provided in pressure contact with the casting roll along the circumference direction, and pressuring it. When a casting roll is used for cooling, the surface temperature of the casting roll is preferably −15 to 30° C. and more preferably −15 to 15° C. in order to obtain a retardation film further excellent in transparency.

When a precursor film is produced by the method (2) of nipping the material between a casting roll and a touch roll and pressuring it, in order to obtain a almost non-oriented precursor film, it is preferable to use, as a touch roll, a rubber roll; a roll having an outer cylinder formed of an elastically deformable metallic endless belt and a roll formed of a flexibly deformable elastic material in the outer cylinder with the space between the outer cylinder and the elastic roll filled with a temperature controlling medium; or a roll having a highly rigid metallic inner cylinder and a thin metallic outer cylinder arranged outside the metallic inner cylinder, with the space between the outer cylinder and the inner cylinder filled with a temperature controlling medium.

When a rubber roll is used as the touch roll, in order to obtain a retardation film having a mirror surface, the molten material extruded from the T-shaped die is preferably nipped between the casting roll and the rubber roll and pressed together with a support. As the support, a biaxially stretched film of a thermoplastic resin having a thickness of 5 to 50 μm is preferable.

When a precursor film is formed by the method (3) of nipping the material between a casting roll and a metallic endless belt which is provided in pressure contact with the casting roll along the circumferential direction of the casting roll, and pressuring it, the endless belt is preferably held by a plurality of rollers arranged along the circumferential direction of the casting roll and in parallel to the casting roll. The endless belt is more preferably held by two rolls having a diameter of 100 to 300 mm. The thickness of the endless belt is preferably 100 to 500 μm.

To obtain a retardation film excellent in optical homogeneity, the variation in thickness of the precursor film to be used as a raw-material film is preferably low. The difference between a maximum thickness value and a minimum thickness value of the precursor film is preferably 10 μm or less and more preferably 4 μm or less.

In the preheating step of this embodiment, although the precursor film, which is obtained by the aforementioned method, etc. and has the aforementioned characteristics, may be used as it is, a thermoplastic resin film longitudinally stretched by a known method, such as a long-span longitudinal stretching and a longitudinal stretching by a roll, is preferably used as a raw-material film. By virtue of this, longitudinal stretching and transverse stretching are successively performed to obtain a retardation film biaxially stretched. A raw-material film can be transversely stretched by a tenter method according to this embodiment and then longitudinally stretched by a known method such as long-span longitudinal stretching and longitudinal stretching by a roll.

As the longitudinal stretching method, a method of stretching a precursor film by using a difference in rotation rate between two or more rolls and a long-span stretching method are mentioned. The long-span stretching method is a method using a longitudinal stretching machine, which has two pairs of nip rollers (consisting of two nip rollers) and an oven arranged between the two pairs of nip rollers. In this method, a precursor film is stretched by using difference in rotation rate of the two pairs of nip rollers while heating the film in the oven. In view of obtaining high optical homogeneity of the resultant retardation film, the long-span longitudinal stretching method is preferable. In the long-span longitudinal stretching method, a hot-air oven of an air floating system is more preferably used.

The hot-air oven of an air floating system refers to an oven having upper nozzles and lower nozzles provided therein so as to spray hot air to both surfaces of the precursor film introduced therein. A plurality of upper nozzles and lower nozzles are alternately arranged in the film-length direction (stretching direction). In the hot-air oven, a precursor film can be longitudinally stretched without being in contact with the upper nozzles and lower nozzles. In this case, the stretching temperature (more specifically, the atmospheric temperature of the hot-air oven) is specified as follows. When the thermoplastic resin contained in a precursor film is an amorphous resin, the stretching temperature preferably falls within the temperature range of the thermoplastic resin: (Tg−20) to (Tg+30)° C. On the other hand, when the thermoplastic resin is a crystalline resin, the stretching temperature preferably falls within the temperature range of the thermoplastic resin: (Tm−40) to (Tm+10)° C. Tg refers to as a glass transition temperature and Tm refers to a melting point.

In the specification, Tg refers to the intermediate-point glass transition temperature obtained in accordance with JIS K7121, and more specifically, it is a value determined from an inflection point of a DSC curve which is obtained by heating a sample once to a melting point or more, then cooling it at a prescribed rate to about −30° C. (in the case of a polypropylene based resin), and then measuring the DSC curve while increasing the temperature of the sample at a prescribed rate, wherein the measurement is performed by using a differential scanning calorimeter (DSC), for example. Cooling temperature can be appropriately changed depending upon the type of resin.

In the specification, the melting point refers to a fusion peak temperature obtained by differential scanning calorimetry in accordance with JIS K7121. The melting point (Tm) of a crystalline polyolefin based resin is generally, 80 to 300° C.

When the hot-air oven used in longitudinal stretching is partitioned into at least two zones, whose temperature can be each independently controlled, the temperature of the zones may be controlled to be the same or different. However, the temperatures (atmospheric temperature of the hot-air oven) of the zones preferably fall within the aforementioned temperature range. The hot-air oven is preferably partitioned into 2 to 4 zones in perpendicular to the film moving direction.

The longitudinal stretching rate can be 1.01 to 3.0-fold. In view of obtaining a retardation film excellent in optical homogeneity, the longitudinal stretching rate is preferably 1.05 to 2.5-fold.

The rotation rate of a nip roll provided on an inlet side of the hot-air oven for use in longitudinal stretching is not particularly limited, however, it is generally, 1 to 20 m/minute. In view of obtaining a retardation film excellent in optical homogeneity, 3 to 10 m/minute is preferable.

The whole length of the hot-air oven used in longitudinal stretching in the film-length direction is not particularly limited; however, it can be 1 to 15 m. In view of obtaining a retardation film excellent in optical homogeneity, the whole length is preferably 2 to 10 m.

When the hot-air oven used in longitudinal stretching is partitioned into a plurality of zones, the number of hot-air blowout nozzles provided in each zone can be generally 5 to 30. In view of obtaining a retardation film excellent in optical homogeneity, the number of nozzles is preferably 8 to 20. When the number of nozzles is excessively large, the curvature of a floating film tends to be excessively large. On the other hand, when the number of nozzles is extremely low, the film rarely floats between the nozzles, in short, a floating operation tends to be rarely performed.

<Transverse Stretching of Raw-Material Film>

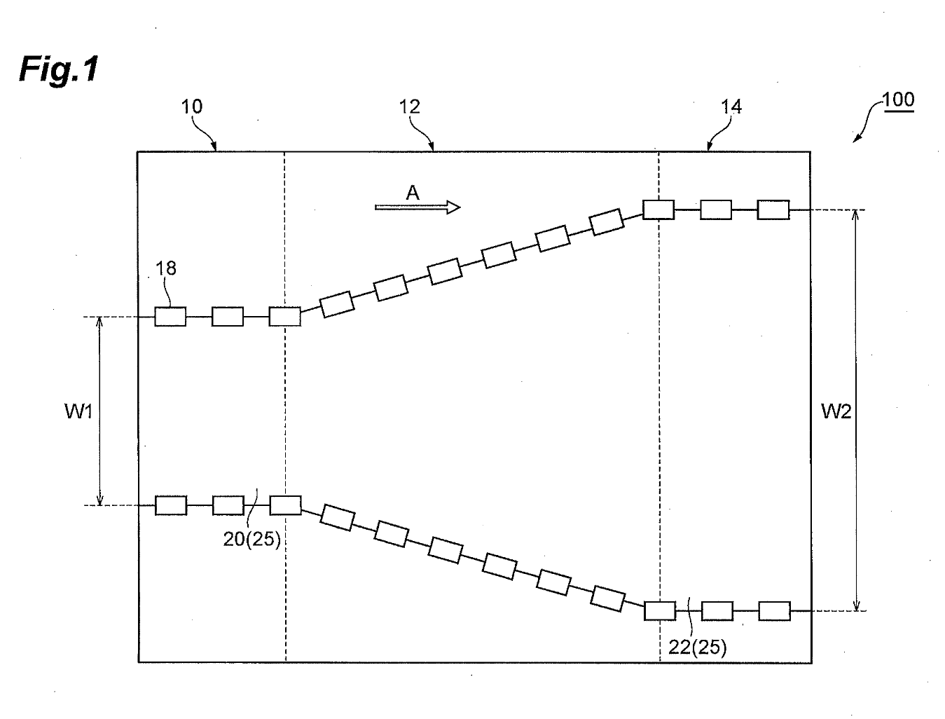

FIG. 1 is a process view schematically showing a step of a method for producing a retardation film according to a preferable embodiment of the present invention. The method for producing a retardation film has a preheating step of preheating a raw-material film 20 with hot air, a stretching step of stretching the raw-material film 20 preheated while heating it with hot air to obtain a stretched film 22, and a heat setting step of heating the stretched film 22 with hot air to stabilize the film.

The method for producing a retardation film according to this embodiment is a method performed by a tenter method. An oven 100 used in this method has a preheating zone 10 for performing the preheating step, a stretching zone 12 for performing the stretching step and a heat setting zone 14 for performing heat setting step. As the oven 100, an oven in which the temperatures of individual zones thereof can be independently controlled is preferred.

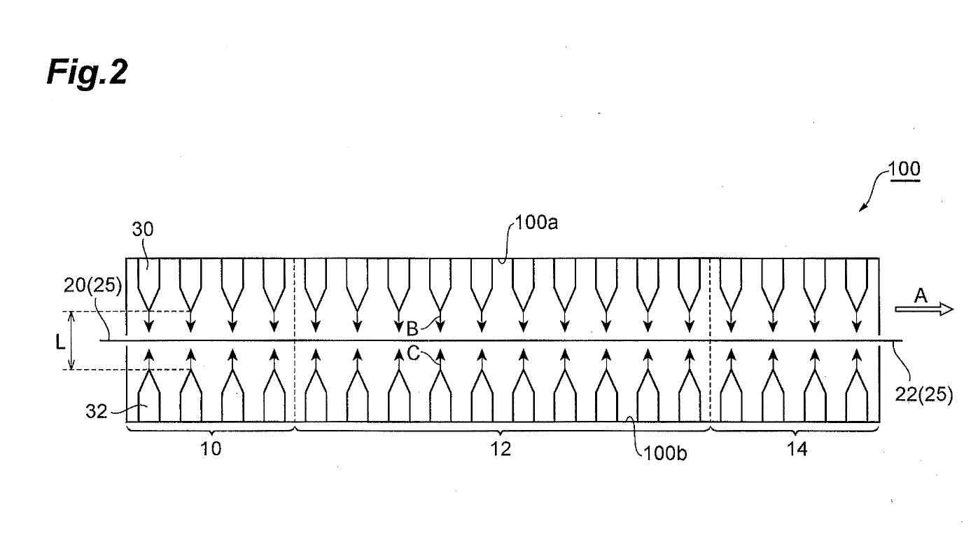

FIG. 2 is a sectional process view schematically showing a step of a method for producing a retardation film according to a preferable embodiment of the present invention. To an upper surface 100a of the oven 100, a plurality of upper nozzles 30 are provided. To a lower surface 100b of the oven 100, a plurality of lower nozzles 32 are provided. The upper nozzles 30 and the lower nozzles 32 are provided so as to face each other vertically.

To describe more specifically, in the preheating zone 10, 4 pairs of nozzles (8 in total) are provided on the upper surface and lower surface in the oven 100. In the stretching zone 12, 10 pairs of nozzles (20 in total) are provided. In the heat setting zone 14, 4 pairs of nozzles (8 in total) are provided. In each zone, the intervals between adjacent nozzles are preferably 0.1 to 1 m in view of uniformly heating a raw-material film and a stretched film and avoiding a complicated structure of the oven, more preferably 0.1 to 0.5 m, and further preferably, 0.1 to 0.3 m.

The upper nozzles 30, which are provided to the upper surface 100a of the preheating zone 10, the stretching zone 12 and the heat setting zone 14, each have a blowout port in the lower portion, from which hot air can be supplied downward (direction of arrow B). On the other hand, the lower nozzles 32, which are provided to each of the lower portions of the preheating zone 10, the stretching zone 12 and the heat setting zone 14, each have a blowout port in the upper portion, from which hot air can be supplied upward (direction of arrow C). Although not shown in FIG. 2, the upper nozzles 30 and lower nozzles 32 each have a depth of a prescribed size in perpendicular to the plane of paper of FIG. 2 so as to heat a raw-material film and a stretched film uniformly in the width direction.

In the method for producing a retardation film of this embodiment, in at least one of the preheating zone 10, the stretching zone 12 and the heat setting zone 14, the blow velocities of hot-air at the blowout ports of all upper nozzles 30 and all lower nozzle 32 are 2 to 12 m/second and the air blow amount from the blowout port per nozzle 30(32) is 0.1 to 1 m³/second per meter of the length of the nozzle along the width direction of a raw-material film and a stretched film. The air blow velocity, in view of obtaining a retardation film further more excellent in optical homogeneity, is preferably 2 to 10 m/second, and more preferably, 3 to 8 m/second. The air blow amount is preferably 0.1 to 0.5 m³/second per meter of the length of the nozzle in the film-width direction in view of obtaining a retardation film further more excellent in optical homogeneity.

Of the preheating zone 10, the stretching zone 12 and the heat setting zone 14, in the preheating zone 10, the air blow velocity is 2 to 12 m/second and the air blow amount from the blowout port per nozzle 30, 32 is preferably 0.1 to 1 m³/second per meter of the length of the nozzle along the film-width direction. In the preheating zone 10, the raw-material film 20 is heated from room temperature to the temperature at which the film can be stretched but the film width remains unchanged since the film is held by chucks 18. The film tends to be drawn down because of thermal expansion. If the blow velocities of hot air from blowout ports of all nozzles 30, 32 in the preheating zone 10 are 2 to 12 m/second and the air blow amount per nozzle 30, 32 is 0.1 to 1 m³/second per meter of the length of the nozzle along the film-width direction, the raw-material film 20 can be sufficiently preheated while preventing hang-down and fluttering of the raw-material film 20. The blow velocities of hot air at the blowout ports of all nozzles 30, 32 in the preheating zone 10 are more preferably 2 to 10 m/second.

The blow velocity of hot air can be measured at the hot-air blowout port of the nozzles 30, 32 by a commercially available hot-wire anemometer. The air blow amount from a blowout port can be obtained by multiplying an air blow velocity by the area of the blowout port. In consideration of measurement accuracy, it is preferable that the blow velocity of hot air be measured at about 10 points at each of the blowout port of each nozzle and the average value of the measurements be used.

In all of the preheating zone 10, the stretching zone 12 and the heat setting zone 14, blow velocities of hot air at the hot-air blowout ports of all nozzles 30, 32 are more preferably 2 to 12 m/second, and further preferably 2 to 10 m/second. By virtue of this, a thermoplastic resin retardation film having more sufficiently uniform phase difference and sufficiently higher axis accuracy can be obtained. Furthermore, in all of the preheating zone 10, the stretching zone 12 and the heat setting zone 14, the air blow amount per nozzle 30, 32 is more preferably 0.1 to 1 m³/second per meter of the length of the nozzle in the film-width direction.

In this embodiment, in the oven 100 having no raw-material film 20 introduced therein, the blow velocity of hot air at a position, at which where a film 25 is to be held is preferably 5 m/second or less in at least one zone selected from the group consisting of the preheating zone 10, the stretching zone 12 and the heat setting zone 14. If the film 25 is heated by use of the hot air as mentioned above, a retardation film more sufficiently excellent in optical homogeneity can be obtained. In particular, in the preheating zone 10, hot air is preferably supplied at a rate of not more than 5 m/second. The raw-material film 20 introduced into the oven 100 is heated in the preheating zone 10 from room temperature to a temperature at which the film can be stretched; however, the transverse width of the film 25 remains unchanged since the film is held by the chucks 18, with the result that the film tends to be drawn down because of thermal expansion. Then, the air blow velocity of the preheating zone 10 is set to not more than 5 m/second to prevent the drawdown and flattering of the film 25.

In all of the preheating zone 10, the stretching zone 12 and the heat setting zone 14, the difference between a maximum value and a minimum value of hot-air blow velocity at the blowout port of each nozzle 30, 32 in the width direction (direction perpendicular to the plane of paper in FIG. 2) is preferably not more than 4 m/second. In this way, if hot air having a small difference in air blow velocity in the width direction is used, a retardation film further more excellent in optical homogeneity in the width direction can be obtained. Thus, by using the hot air having a small difference in air blow velocity, a retardation film having further higher optical homogeneity can be obtained.

In the oven 100, in at least one zone selected from the group consisting of the preheating zone 10, the stretching zone 12 and the heat setting zone 14, the distance L (the shortest distance) between the upper nozzle 30 and the lower nozzle 32 facing each other is preferably 150 mm or more, more preferably 150 to 600 mm and further preferably 150 to 400 mm. By arranging the upper nozzles and the lower nozzles at the distance L as described above, fluttering of the film in each step can be inhibited more certainly.

At the blowout ports of individual nozzles 30, 32, which are provided in at least one zone selected from the group consisting of the preheating zone 10, the stretching zone 12 and the heat setting zone 14, the differences between maximum temperatures and minimum temperatures (ΔT) of hot air in the width direction (direction perpendicular to the plane of paper in FIG. 2) are all preferably 2° C. or less, and more preferably 1° C. or less. In this way, if the film is heated with the hot air having a sufficiently small temperature difference in the width direction as mentioned above, the variation of orientation in the width direction can be further inhibited. When a raw-material film is formed of a polypropylene based resin, the hot air to be used preferably has a temperature difference (ΔT) as mentioned above of 2° C. or less in a temperature range of 80 to 170° C. in which the raw-material film is stretched, and more preferably 1° C. or less.

A retardation film, which is used by installing it in a display section of a liquid crystal display device, preferably has a low amount of foreign matter attached. For the reason, the cleanliness factor of the oven 100 is preferably adjusted to air cleanliness class 1000 or less. In the specification, the “air cleanliness class” refers to the air cleanliness class defined by the USA Federal Standard (USA FED. STD) 209D, and the “air cleanliness class 1000” means that the atmosphere contains microparticles having a particle size of 0.5 μm or less in an amount of not more than 1000 particles/ft³. The air cleanliness class 1000 defined by the USA Federal Standard 209D corresponds to air cleanliness class 6 defined by JIS B 9920, “evaluation method of air cleanliness in a clean room”.

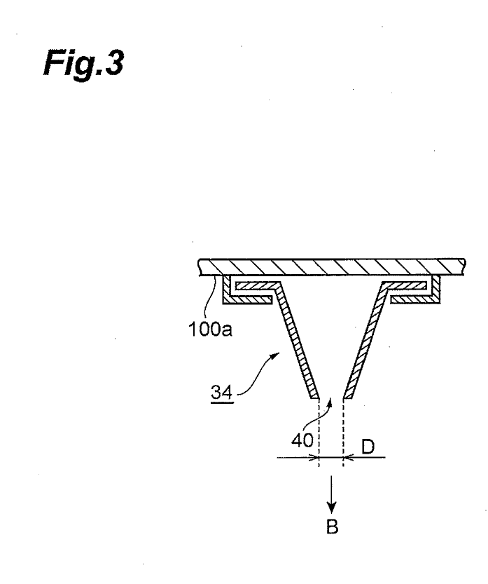

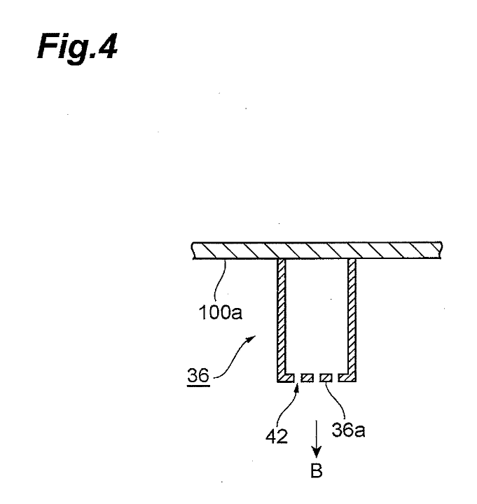

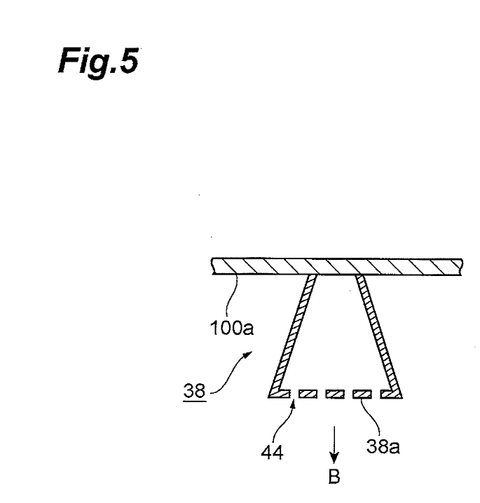

FIG. 3 is a schematic sectional view showing an example of a shape of a jet nozzle preferably used in a method for producing a retardation film of the present invention. FIG. 4 is a schematic sectional view showing an example of a shape of a punching nozzle preferably used in a method for producing a retardation film of the present invention. FIG. 5 is a schematic sectional view showing another shape of a punching nozzle preferably used in a method for producing a retardation film of the present invention. In this embodiment, the oven 100 preferably has either one or both of the jet nozzle as shown in FIG. 3 and the punching nozzle as shown in FIG. 4 and FIG. 5.

FIG. 3 shows a jet nozzle 34 and FIG. 4 and FIG. 5 show a punching nozzle 36 and a punching nozzle 38, respectively. The jet nozzle 34 of FIG. 3, the punching nozzle 36 of FIG. 4 and the punching nozzle 38 of FIG. 5, which are provided on the upper surface 100a of the oven 100, are configured to supply hot air downward (direction of arrow B). The jet nozzle 34, punching nozzle 36 and punching nozzle 38, which are provided on the lower surface 100b of the oven 100, are configured to supply hot air upward (direction of arrow C in FIG. 2). Although not shown in FIGS. 3 to 5, the nozzles 34, 36, 38 each have a depth of a prescribed size in the direction perpendicular to the plane of the paper of FIG. 2. The length of the depth is preferably longer than the length of the width of the film 25.

The jet nozzle 34 has a slit 40 extending in the film-width direction as a blowout port for hot air. The slit width D of the slit 40 is preferably 5 mm or more, and more preferably 5 to 20 mm. If the slit width D is set to 5 mm or more, the optical homogeneity of the resultant retardation film can be further more improved. The area of the blowout port per jet nozzle 34 can be obtained by multiplying the length of the jet nozzle 34 in the width direction of the nozzle (in the depth direction of FIG. 3) by the slit width D. The product obtained by multiplying the area of the blowout port per nozzle by an air blow velocity is equal to the hot-air blow amount per nozzle. The hot-air blow amount is divided by the length of the slit 40 along the film-width direction to obtain the hot-air blow amount per meter of the length of the nozzle along the film-width direction.

The punching nozzle 36, when it is cut in perpendicular to the longitudinal direction, has a rectangular sectional shape, as shown in FIG. 4. The punching nozzle 36 has a plurality of openings 42, for example, circular openings, in a lower surface 36a facing the film 25. The hot-air blowout port of the punching nozzle 36 is constituted of a plurality of openings 42 provided in the surface 36a. The openings 42 are hot-air blowout ports, and hot air is supplied from the openings 42 at a prescribed blow velocity. The openings 42 are arranged not only in the longitudinal direction of the film 25 but also in the width direction. The openings 42 can be arranged, for example, in a zigzag fashion. The area of the blowout port per punching nozzle 36 is obtained by adding the areas of all openings 42 provided in a single punching nozzle 36. The product obtained by multiplying the area of the blowout port per nozzle by an air blow velocity is equal to the hot-air blow amount per nozzle. When the hot-air blow amount is divided by the length of the film along the width direction, the hot-air blow amount per meter of the length of the nozzle along the film-width direction can be obtained.

The punching nozzle 38, when it is cut in perpendicular to the longitudinal direction, has a trapezoidal sectional shape which gradually spreads wide toward a surface 38a facing the film 25 as shown in FIG. 5. The punching nozzle 38 has a plurality of openings 44, for example, circular openings, in the lower surface 38a facing the film. The hot-air blowout port of the punching nozzle 38 is constituted of a plurality of openings 44 provided in the surface 38a. The openings 44 are hot-air blowout ports, and hot air is supplied from the openings 44 at a prescribed blow velocity. The openings 44 are arranged not only in the longitudinal direction of the film 25 but also in the width direction. The openings 44 can be arranged, for example, in a zigzag fashion. The area of the blowout port per punching nozzle 38 is obtained by adding all openings 44 provided in a single punching nozzle 38. The product obtained by multiplying the area of the blowout port per nozzle by an air blow velocity is equal to the hot-air blow amount per nozzle.

When the punching nozzle 36 or 38 is used, the difference between a maximum hot-air blow velocity and a minimum hot-air blow velocity at the blowout port of a nozzle in the width direction can be obtained as the difference between a maximum blow velocity and a minimum blow velocity of hot air supplied from a plurality of openings 42 or 44 provided in the same nozzle 36 or 38. The difference between a maximum temperature and a minimum temperature of hot air at the blowout port of a nozzle in the width direction can be similarly obtained.

If all nozzles provided in the oven 100 are punching nozzle 36 or 38, the total area of the hot-air blowout ports in the entire oven 100 can be increased. As a result, the pressure of hot air applied to the film 25 can be reduced, thereby further reducing the flatting of the film 25. Consequently, the optical homogeneity of the resultant retardation film can be further improved. In particular, in the preheating zone 10, the raw-material film 20 is heated from room temperature to the temperature at which the film can be stretched, but the width (length in the transverse direction) of the raw-material film 20 remains unchanged since the film is held by chucks, so that the film tends to be drawn down because of thermal expansion. However, if the punching nozzle 36 or 38 is used in the preheating zone 10, hand-down and flattering of the raw-material film 20 can be further inhibited.

The size and number of the openings 42, 44 provided in the surface 36a, 38a of the punching nozzle 36, 38 can be appropriately varied as long as a hot-air blow velocity at each opening 42, 44 is 2 to 12 m/second and the air blow amount from each nozzle is 0.1 to 1 m³/second per meter of the length of the nozzle along the film-width direction.

In view of obtaining a more uniform blow velocity of air from the openings of the punching nozzle 36, 38, the openings 42, 44 preferably have a circular shape. In this case, the diameter of the opening 42, 44 is preferably 2 to 10 mm, and more preferably 3 to 8 mm.

When the punching nozzle 36, 38 is used, the length of the surface 36a, 38a per nozzle in the longitudinal direction of the film (moving direction) is preferably 50 to 300 mm. The intervals between adjacent punching nozzles are preferably 0.3 m or less. Moreover, the ratio of the total area (blowout port area) of the openings 42, 44 of the punching nozzle 36, 38 relative to the length of the punching nozzle 36, 38 in the film-width direction (the total area of the openings of the punching nozzle (m²)/length (m) of the punching nozzle in the film-width direction) is preferably 0.008 m or more.

If the punching nozzle 36, 38 mentioned above is used, the area of hot-air blowout ports can be increased. By virtue of this, hot air can be supplied at a sufficiently reduced velocity and a sufficiently large amount, enabling further more uniform heating of the film. Therefore, a film having further more uniform phase difference and further higher axis accuracy can be produced.

The method for producing a retardation film of this embodiment has a preheating step of heating a thermoplastic resin film with hot air, a stretching step of stretching the thermoplastic resin film preheated in the width direction while heating it with hot air to obtain a stretched film, and a heat setting step of heating the stretched film with hot air. Individual steps of the method for producing a retardation film according to this embodiment will be more specifically described below.

(Preheating Step)

In the preheating step, the raw-material film 20 formed of a thermoplastic resin and having a width W1 is introduced into the preheating zone 10 of the oven 100 to perform preheating (FIG. 1). In the preheating step, which is a step carried out before the stretching step of stretching the raw-material film 20 in the width direction (transverse direction), the raw-material film 20 is heated to a sufficient temperature at which the raw-material film 20 can be stretched.

The raw-material film 20 is fixed by the chucks 18 and introduced into the preheating zone 10 by movement of the chucks 18 toward the direction A. The raw-material film 20 is transferred by movement of the chucks 18 in the direction A while being heated in the preheating zone 10. The moving rate of the raw-material film 20 within the oven 100 is appropriately controlled generally within the range of 0.1 to 50 m/minute.

The preheating temperature in the preheating step, in the case where the thermoplastic resin contained in the raw-material film 20 is an amorphous resin, is preferably (Tg−20) to (Tg+30)° C. On the other hand, in the case where the thermoplastic resin contained in the raw-material film 20 is a crystalline resin, the preheating temperature is preferably (Tm−40) to (Tm+20)° C. The preheating temperature herein refers to the atmospheric temperature of the preheating zone 10 in the oven 100 in which a preheating step is performed.

When the raw-material film 20 is formed of a polypropylene based resin, the preheating temperature preferably falls within the range (T₁−10) to (T₁+10)° C. and more preferably (T₁−5) to (T₁+5)° C. in order to improve the uniformity of the phase difference of the resultant retardation film, where T₁ is the melting point of the polypropylene based resin.

In the preheating step, in the case where the thermoplastic resin is an amorphous resin, the raw-material film 20 is preferably heated to a temperature within the range of (Tg−20) to (Tg+30)° C. by the time the next stretching step starts. On the other hand, in the case where the thermoplastic resin contained in the raw-material film 20 is a crystalline resin, the raw-material film 20 is preferably heated to temperature within the range of (Tm−40) to (Tm+20)° C.

The preheating zone 10, in which the preheating step is performed, preferably has a length of 0.5 to 10 m in the feed direction of the raw-material film 20. When the length of the preheating zone 10 is less than 0.5 m, the raw-material film is not sufficiently preheated, with the result that the optical homogeneity of the retardation film tends to be undermined. On the other hand, when the length of the preheating zone 10 exceeds 10 m, the size of the oven 100 increases, with the result that the manufacturing cost of the retardation film tends to increase.

(Stretching Step)

The stretching step is carried out in the stretching zone 12 of the oven 100. After completion of the preheating step in the preheating zone 10, the raw-material film 20 is transferred in the direction of arrow A and introduced from the preheating zone 10 into the stretching zone 12.

The stretching step is a step of stretching the raw-material film 20 preheated in the preheating step in the width direction (direction perpendicular to the arrow A direction) while heating. The stretching temperature (atmospheric temperature of the stretching zone 12) in the stretching step may be lower or higher than, or equal to the preheating temperature. When the raw-material film 20 is formed of a polypropylene based resin, the raw-material film 20 can be further uniformly stretched if the raw-material film 20 preheated is stretched at a temperature lower than that of the preheating step. As a result, a retardation film having more excellent uniformity of phase difference can be obtained. When the raw-material film 20 is formed of a polypropylene based resin, the stretching temperature is preferably lower by 5 to 20° C. than the preheating temperature of the preheating step, and more preferably lower by 7 to 15° C. The stretching temperature used herein refers to an atmospheric temperature of the stretching zone 12 in the oven 100 in which the stretching step is performed.

In the stretching step, the transverse stretching of the raw-material film 20 is performed by spreading the chucks 18 for fixing the raw-material film 20 in the width direction (direction perpendicular to the arrow A direction). More specifically, by gradually spreading the chucks 18 in the width direction while the chucks 18 are moved in the A direction, the raw-material film 20 is pulled in the transverse direction and transversely stretched. By virtue of the stretching step, the raw-material film 20 having a width W1 is transversely stretched to obtain a film having a width W2.

In the stretching step, the transverse stretching rate of the raw-material film 20 is preferably 2 to 10-fold. In view of further improving the optical homogeneity of the resultant retardation film, the transverse stretching rate is more preferably 4 to 7-fold.

The stretching zone 12, in which the stretching step is performed, preferably has a length of 0.5 to 10 m in the feeding direction A of the raw-material film 20. When the length of the stretching zone 12 is less than 0.5 m, the raw-material film 20 is not sufficiently stretched, with the result that the optical homogeneity of the retardation film tends to be undermined. On the other hand, when the length of the stretching zone 12 exceeds 10 m, the size of the oven 100 increases, with the result that the manufacturing cost of the retardation film tends to increase.

In the stretching step of this embodiment, the raw-material film 20 is stretched only transversely; however, longitudinal stretching and transverse stretching both can be performed. In this case, the raw-material film 20 is stretched by the chucks 18 for fixing the raw-material film 20 in the width direction (direction perpendicular to the arrow A direction) and the length direction (direction parallel to the arrow A direction) simultaneously or successively. The raw-material film 20 can be stretched in the length direction by spreading the interval between the adjacent chucks 18 in the stretching zone 12.

(Heat Setting Step)

The stretching step is performed in the heat setting zone 14 in the oven 100. After completion of the stretching step in the stretching zone 12, the stretched film 22 is transferred in the direction of arrow A and introduced from the stretching zone 12 to heat setting zone 14.

The heat setting step is a step of stabilizing the optical characteristics of the stretched film 22 by heating the stretched film 22 in the heat setting zone 14 maintained at a heat setting temperature (atmospheric temperature in the heat setting zone 14) while keeping the same transverse width W2 as that at the completion time of the stretching step. The heat setting temperature may be lower or higher than, or equal to the stretching temperature of the stretching step. In view of further improving optical characteristics of the retardation film such as phase difference and optical axis, the heat setting temperature preferably falls within the temperature range from a temperature lower by 10° C. than the stretching temperature to a temperature higher by 30° C. than the stretching temperature.

The heat setting zone 14, in which the heat setting step is performed, has a length of 0.5 to 10 m in the feeding direction A of the raw-material film 20. When the length of the heat setting zone 14 is less than 0.5 m, the stretched film 22 is not sufficiently stabilized and the optical homogeneity of the retardation film tends to be undermined. On the other hand, when the length of the heat setting zone 14 exceeds 10 m, the size of the oven 100 increases, with the result that the manufacturing cost of the retardation film tends to increase.

The method for producing a retardation film according to this embodiment may further have a thermal relaxation step. The thermal relaxation step can be performed between the stretching step and the heat setting step. Accordingly, the thermal relaxation step may be performed by providing a thermal relaxation zone, whose temperature can be set independently of the other zones, between the stretching zone 12 and the heat setting zone 14 or performed in the heat setting zone 14.

In the thermal relaxation step, after the film is stretched in the stretching step to a prescribed width W2, the interval between the adjacent chucks is reduced only by several % (preferably 0.1 to 10%), so that useless distortion can be removed from the stretched film 22. By removing the distortion, a retardation film further more excellent in optical homogeneity can be obtained.

The phase difference desired for the retardation film varies depending upon the type of liquid crystal display device to which the retardation film is to be installed; however, an in-plane phase difference R₀ is generally 30 to 300 nm. When the retardation film is used in a vertical alignment orientation (VA) mode liquid crystal display, an in-plane phase difference R₀ is preferably 40 to 70 nm and a thickness-direction phase difference Rₜₕ is preferably 90 to 230 nm in view of ensuring an excellent view angle. The thickness of the retardation film is generally, 10 to 100 μm, and preferably 10 to 60 μm. By controlling the stretching conditions such as a stretching rate and temperature in the longitudinal stretching and transverse stretching steps in producing a retardation film and the thickness of the retardation film to be produced, a retardation film having a desired phase difference can be obtained.

In the specification, the in-plane phase difference R₀ and thickness-direction phase difference Rₜₕ of a retardation film are defined by the following expressions (I) and (II), respectively.

R₀=(nₓ−n_{y})×d (I)

Rₜₕ={(nₓ+n_{y})/2−n_{z}}×d (II)

In the expressions (I) and (II), nₓ is a refractive index in the slow axis direction in the film plane (the direction in which the refractive index becomes maximum) of a retardation film; and n_{y} is a refractive index in the fast axis direction in the film plane (the direction in which the refractive index becomes minimum) of the retardation film. Furthermore, n_{z} is a refractive index in the thickness-direction of the retardation film; and d is the thickness (unit: nm) of the retardation film.

In the specification, the optical axis refers to the azimuth direction at which the in-plane refractive index of the retardation film reaches a maximum, in short, the in-plane slow axis. The angle of the optical axis refers to the angle formed between the stretching direction of a thermoplastic resin film and the in-plane slow axis of the thermoplastic resin film and is sometimes called an orientation angle. More specifically, assuming that the stretching direction of a thermoplastic resin film is regarded as a reference line (0°), the angle of the optical axis refers to the angle formed between the reference line and the in-plane slow axis. The angle of the optical axis can be measured by a commercially available polarizing microscope and an automatic birefringence meter.

By virtue of the method for producing a retardation film according to this embodiment, it is possible to obtain a retardation film having high optical homogeneity, the retardation film having a difference between a maximum value and a minimum value of in-plane phase difference of 15 nm or less when the angle of the optical axis (500 mm) is measured in the film-width direction, and the optical axis falling within the range of −5 to +5°.

The retardation film is laminated together with various types of polarizing plates and liquid crystal layers and used preferably as liquid crystal display devices of mobile phones, personal digital assistants (PDA), personal computers and big-screen televisions, etc.

Examples of the liquid crystal display device (LCD) in which the retardation film according to this embodiment is to be laminated include various-mode liquid crystal display devices such as an optically compensated bend (OCB) mode, a vertical alignment (VA) mode, in-plane switching (IPS) mode, a thin film transistor (TFT) mode, a twisted nematic (TN) mode and a super twisted nematic (STN) mode devices.

According to the production method of this embodiment, it is possible to obtain a thermoplastic resin retardation film excellent in optical homogeneity, in short, having high axis accuracy and uniform phase difference. The retardation film, even if it is used particularly in a big-screen liquid crystal display such as a big-screen television, does not virtually have phase difference due to optical inhomogeneity and variation of optical axis, effectively improving dependency upon the view angle. The aforementioned liquid crystal display device provided with the retardation film having high axis accuracy and uniform phase difference is excellent in view angle characteristics and durability.

In the foregoing, preferable embodiments of the present invention have been described; however, the present invention is not limited to the aforementioned embodiments.

### EXAMPLES

The present invention will be more specifically described based on Examples and Comparative Examples; however, the present invention is not limited to the following examples.

In Examples and Comparative Examples, the amount of a component of a polypropylene based resin soluble in xylene and the content of ethylene were obtained by the following procedures.

<Amount of Component Soluble in Xylene (CXS)>

After a sample (1 g) of a polypropylene based resin was completely dissolved in xylene (100 ml) in a boiling (reflux) state, the solution was cooled to 20° C. and allowed to stand still at the same temperature for 4 hours. Thereafter, filtration was performed to separate a precipitate from a filtrate. Xylene was distilled away from the filtrate and the solid substance produced was dried under reduced pressure at 70° C. The percentage of the mass of the remainder obtained by the drying process relative to the original mass (1 g) of the sample was the amount of the component (CXS) of the polypropylene based resin soluble in xylene at 20° C.

<Content of Ethylene>

A polypropylene based resin was subjected to measurement for an IR spectrum in accordance with the method described in Polymer Analysis Handbook (issued by KINOKUNIYA Company Ltd. 1995), on page 616, to obtain the content of an ethylene-derived constitutional unit of the polypropylene based resin.

### Example 1

### Extrusion Molding

### Precursor Film

A polypropylene based resin (propylene-ethylene random copolymer, Tm=136° C., MFR=8 g/10 minutes, ethylene content=4.6% by mass, CXS=4% by mass) was loaded in a 65 mm φ extruder having a cylinder temperature controlled to 250° C., melted and kneaded, and extruded from T-shaped die having a width of 1200 mm and provided to the extruder at an extrusion amount of 65 kg/h.

The molten polypropylene based resin extruded was nipped between 400 mm φ casting roll whose temperature was controlled to be 12° C. and a touch roll, which consisted of an outer cylinder formed of metal sleeve and an elastic roll placed in the outer cylinder, and whose temperature was controlled to be 12° C., and pressed to cool. In this way, the resin was processed into a polypropylene based resin film having a thickness of 80 μm and a width of 940 mm. The air gap was 115 mm and the molten polypropylene based resin was nipped between the casting roll and touch roll and pressed at a distance of 20 mm.

<Longitudinal Stretching>

The resultant polypropylene based resin film was introduced into a long-span longitudinal stretching machine, which had two pairs of nip rolls and an oven of an air floating system between the two pairs of nip rolls, and longitudinally stretched. The oven was partitioned into a first zone near the inlet side (through which the polypropylene based resin film is introduced) and a second zone near the outlet side and the length of each zone was 1.5 m (the whole length of the oven: 3.0 m).

The longitudinal stretching was performed in the conditions: the temperature of the first zone: 122° C., the temperature of the second zone: 126° C., the feed rate of the polypropylene based resin film at the inlet of the oven was 6 m/minute and longitudinal stretching rate was 2 fold. The thickness of the longitudinally stretched film was 57 μm and the width thereof was 650 mm. The in-plane phase difference R₀ of the longitudinally stretched film was measured in a range of 500 mm in width in the center portion in the width direction at intervals of 50 mm at 11 points. The average value of the in-plane phase difference R₀ was 670 nm and the thickness-direction phase difference Rₜₕ was 350 nm.

<Transverse Stretching>

Next, the longitudinally stretched film was transversely stretched by a tenter method to prepare a retardation film. The oven to be used in the tenter method had a first chamber (length: 1.2 m), a second chamber (length: 1.3 m), a third chamber (length: 1.3 m) and a fourth chamber (length: 0.9 m) (the whole length of the oven: 4.7 m), which were arranged in this order sequentially from the upstream side (inlet side of the oven) in the feed direction of the longitudinally stretched film and in which the temperature and blow velocity of hot air were able to be controlled independently of each other, and the first chamber was used as the preheating zone, the second and third chambers were used as the stretching zone, and the fourth chamber was used as the heat setting zone. The length of each chamber and the whole length of the oven are those along with the film-feed direction.

Type of nozzles in the preheating zone, stretching zone and heat setting zone were as shown in Table 1. More specifically, in the preheating zone and heat setting zone, a punching nozzle was used as a nozzle for supplying hot air and in the stretching zone, a jet nozzle was used as a nozzle for supplying hot air. In the preheating zone, 12 punching nozzles (6 pairs) were provided and 10 punching nozzles (5 pairs) were provided in the heat setting zone. The punching nozzles were arranged at equal intervals in the oven. The distance between the upper nozzles and the lower nozzles facing each other was 200 mm. The punching nozzles had a shape shown in FIG. 5, and the length of the punching nozzle 38 in the film-width direction was 1100 mm. The diameter of each circular opening 44 in the punching nozzle 38 was 5 mm.

In each zone, the area of each blowout port of a nozzle was as shown in Table 2. More specifically, in each punching nozzle 38 provided in the preheating zone and heat setting zone, the total area of the openings 44 per nozzle, in short, the area of a blowout port, was 0.011 m² per meter of the length of the nozzle along the film-width direction. The length of the surface 38a of each punching nozzle 38 in the film-feed direction was 100 mm.

In the stretching zone, 24 jet nozzles (12 pairs) were provided and arranged at equal intervals in the oven. The distance between the upper nozzles and the lower nozzles facing each other was 200 mm. The jet nozzle has a shape shown in FIG. 3 and the length of the jet nozzle 34 in the film-width direction was 1100 mm. The width D of the slit 40 in each jet nozzle 34 was 5 mm and in each nozzle, the area of the slit 40, in short, the area of the blowout port, was 0.005 m² per meter of the length of the nozzle along the film-width direction.

The transverse stretching by a tenter method is performed by passing the film vertically in the middle of the oven. To describe more specifically, the transverse stretching was performed in the conditions: the preheating temperature of the preheating zone: 140° C., the stretching temperature of the stretching zone: 130° C., the heat setting temperature of the heat setting zone: 130° C., the transverse stretching rate: 4 fold, the line speed: 1 m/minute and the distance between the chucks at the outlet of the oven: 600 mm, to obtain a retardation film. The line speed herein refers to the moving speed of the film in the oven.

The hot-air blow velocity from each nozzle in each zone was set as shown in Table 2. More specifically, in the preheating zone and heat setting zone, the hot-air blow velocity at the blowout port of each punching nozzle 38 was set to 11 m/second, and the air blow amount per punching nozzle 38 was set to 0.121 m³/second per meter of the length of the nozzle along the film-width direction. In the stretching zone, the hot-air blow velocity at the blowout port of each jet nozzle 34 was set to 15 m/second. The air blow amount per jet nozzle 34 was set to 0.075 m³/second per meter of the length of the nozzle along the film-width direction of the stretched film.

In each punching nozzle 38 and each jet nozzle 34, the difference between a maximum blow velocity and a minimum blow velocity of hot air at a blowout port was 0.7 m/second. The difference in temperature of hot air from each punching nozzle 38 and each jet nozzle 34 arranged in each zone in the width direction was at most 1° C. The blow velocity, the blow amount and the temperature difference of hot air were values measured by the following methods.

<Measurement of Blow Velocity and Blow Amount of Hot Air>

The blow velocity of air supplied from the punching nozzle 38 and jet nozzle 34 was measured as follows. In each of the upper and lower nozzles arranged around the center of each chamber in the film-feed direction relative to the film moving direction, a pair of points were defined, which were positioned at a distance of 100 mm from both ends of each nozzle toward the center in the width direction (depth direction) of each nozzle and the interval between the pair of points was partitioned into four portions to define three partition points. At these five points in total, the blow velocity of hot air was measured by a heat-wire anemometer. To describe more specifically, in each chamber, the blow velocity of hot air from an upper nozzle and a lower nozzle was measured at 10 points in total by a commercially available hot-wire anemometer. Subsequently, an average value of these was obtained and regarded as the hot-air blow velocity from each nozzle in each chamber. When the zone is constituted of a single chamber, the hot-air blow velocity in the chamber is regarded as the hot-air blow velocity in the zone. When the zone is constituted of a plurality of chambers (for example, the case of the stretching zone in Example 1), the average value of hot-air blow velocity s of individual chambers was regarded as the hot-air blow velocity of the zone. In each chamber, the blow velocity of air was measured at 10 points. Based on the air blow velocity s, a maximum air blow velocity and a minimum air blow velocity were obtained and the difference between them was obtained by calculation. This was regarded as the difference of the hot-air blow velocity in each chamber. Of the hot-air blow velocity differences of individual chambers, the maximum one was regarded as a maximum air blow velocity difference. The hot-air blow amount was obtained by multiplying the area of the blowout port by the hot-air blow velocity obtained as described above.

<Determination of Temperature Difference of Hot Air>

The temperature difference of hot air in the punching nozzle 38 and jet nozzle 34 was obtained by measurement as follows. In the same manner as in the aforementioned process for measuring a hot-air blow velocity, temperature was measured in each chamber at total 10 points of the upper nozzle and the lower nozzle by a thermocouple. Of the temperature measurement data at the 10 points, the difference between a maximum temperature and a minimum temperature was obtained by calculation and regarded as the temperature difference of hot air in the width direction of each chamber. The maximum value of the temperature differences of individual chambers was regarded as the maximum temperature difference.

Next, the retardation film obtained by transversely stretching a longitudinally stretched film by the tenter method was evaluated as follows.

<Measurement of In-Plane Phase Difference R₀, Thickness-Direction Phase Difference Rₜₕ and In-Plane Phase Difference Variation ΔR₀>

The in-plane phase difference value R₀ was measured by use of a phase difference measurement apparatus (trade name: KOBRA-CCD, manufactured by Oji Scientific Instruments). To describe more specifically, measurement was performed in the center portion of a prepared retardation film (in the range of 320 mm in width) in the film-width direction at intervals of 20 mm, and an average value thereof was regarded as the in-plane phase difference R₀ of the retardation film. The difference of a maximum measurement value and a minimum measurement value was obtained by calculation and regarded as an in-plane phase difference variation (ΔR₀). When the in-plane phase difference variation is 15 nm or less, evaluation “A” was given. When the in-plane phase difference variation exceeds 15 nm, evaluation “B” was given. The thickness-direction phase difference Rₜₕ was measured in the center portion of the retardation film in the width direction by a phase difference measurement apparatus (trade name: KOBRA-WPR, manufactured by Oji Scientific Instruments).

<Measurement of Angle of Optical Axis>

In the center portion of a prepared retardation film, the angle of the optical axis was measured by use of a polarizing microscope in the range of 320 mm in width in the width direction at intervals of 20 mm. In the measurement, when the angles of the optical axis of all measurement points fall within the range of −5° or more and +5° or less, evaluation “A” was given. Of the values of the all measurement points, if there was a value less than −5° or more than +5°, evaluation “B” was given.

As a result of the evaluation, the in-plane phase difference R₀ was 50 nm, the thickness-direction phase difference Rₜₕ was 90 nm, the difference between a maximum valve and a minimum valve of the in-plane phase difference R₀ (in-plane phase difference variation ΔR₀) in the 320-mm width range was 10 nm and the angle of the optical axis was −4.1 to +3.0°. From these results, it was found that the retardation film is excellent in optical homogeneity.

### Comparative Example 1

A retardation film was prepared and evaluated in the same manner as in Example 1 except that the transverse stretching conditions were changed as follows. To describe more specifically, in the transverse stretching by a tenter method, as the hot-air blowout nozzle used in the preheating zone and heat setting zone, the same jet nozzle 34 as used in the stretching zone of Example 1 was used (Table 1). In the preheating zone, 12 (6 pairs of) jet nozzles 34 were provided. In heat setting zone, (5 pairs of) jet nozzles 34 were provided. The jet nozzles 34 were arranged at equal intervals in the oven.

In all of the preheating zone, the stretching zone and the heat setting zone, the hot-air blow velocity at the blowout port of each jet nozzle 34 was set to 15 m/second and the air blow amount per nozzle was set to 0.075 m³/second per meter of the length of the nozzle along the film-width direction. A retardation film was prepared in the same conditions as in Example 1 except the aforementioned conditions. The in-plane phase difference R₀, thickness-direction phase difference Rₜₕ, in-plane phase difference variation ΔR₀ and the angle of the optical axis were measured. The measurement results were as shown in Table 3.

A maximum temperature difference and a maximum blow velocity difference of hot air obtained in the same manner as in Example 1 were as shown in Table 2.

As shown in Table 3, the in-plane phase difference R₀ of the resultant retardation film was 80 nm, the thickness-direction phase difference Rₜₕ was 100 nm, the in-plane phase difference variation (ΔR₀) was 35 nm and the angle of the optical axis was −3.1 to +7.7° Compared to the film obtained in Example 1, the optical homogeneity was low in phase difference and optical axis.

### Comparative Examples 2 and 3

A retardation film was prepared and evaluated in the same manner as in Comparative Example 1 except that, in the transverse stretching by a tenter method, the air blow velocity and amount of hot air in each zone were set at the values shown in Table 2. The maximum temperature difference and the maximum blow velocity difference of hot air, which were obtained in the same manner as in Example 1, were as shown in Table 2. The evaluation results of the retardation film were as shown in Table 3.

As shown in Table 3, the retardation film prepared in Comparative Example 2 had an in-plane phase difference R₀ of 100 nm, a thickness-direction phase difference Rₜₕ of 80 nm, an in-plane phase difference variation (ΔR₀) of 57 nm and an angle of optical axis of −1.1 to +2.0°. The uniformity of the optical axis was excellent; however, the uniformity of the phase difference was low compared to that of Example 1.

The retardation film prepared in Comparative Example 3 had an in-plane phase difference R₀ of 50 nm, a thickness-direction phase difference Rₜₕ of 105 nm, an in-plane phase difference variation (ΔR₀) in the 320 mm range in width of 27 nm and an angle of optical axis of −5.8 to +9.5°. Optical homogeneity was low in phase difference and optical axis compared to those obtained in Example 1.

### Comparative Example 4

A retardation film was prepared and evaluated in the same manner as in Comparative Example 3 except that, in the transverse stretching by a tenter method, the line speed was set to 10 m/minute. The maximum temperature difference and the maximum blow velocity difference of hot air, which were obtained in the same manner as in Example 1, were as shown in Table 2. The evaluation results of the retardation film were as shown in Table 3.

The resultant retardation film had an in-plane phase difference R₀ of 50 nm, a thickness-direction phase difference Rₜₕ of 95 nm, an in-plane phase difference variation (ΔR₀) of 28 nm and an angle of optical axis of −5.6 to +6.9°. Optical homogeneity was low in phase difference and optical axis compared to those obtained in Example 1.

### Comparative Examples 5 and 6

A retardation film was prepared and evaluated in the same manner as in Example 1 except that, in the transverse stretching by a tenter method, the air blow velocity and air blow amount in each zone were set to the numerical values shown in Table 2. The maximum temperature difference and the maximum blow velocity difference of hot air, which were obtained in the same manner as in Example 1, were as shown in Table 2. The evaluation results of the retardation film were as shown in Table 3.

The retardation film prepared in Comparative Example 5 had an in-plane phase difference R₀ of 80 nm, a thickness-direction phase difference Rₜₕ of 90 nm, an in-plane phase difference variation (ΔR₀) of 39 nm and an angle of optical axis of −2.7 to −1.1°. The uniformity of the optical axis was excellent; however, the uniformity of phase difference was low compared to that of Example 1.

The retardation film prepared in Comparative Example 6 had an in-plane phase difference R₀ of 50 nm, a thickness-direction phase difference Rₜₕ of 95 nm, an in-plane phase difference variation (ΔR₀) of 6 nm and an angle of optical axis of −7.4 to +9.1°. The uniformity of the phase difference was excellent; however, the uniformity of optical axis was low compared to that of Example 1.

### Example 2

A retardation film was prepared and evaluated in the same manner as in Example 1 except that, in the transverse stretching by a tenter method, as the hot-air blowout nozzle in the heat setting zone, the jet nozzle 34 used in the stretching zone of Example 1 was used (Table 1) and that the blow velocity and blow amount of hot air in each zone were set to the numerical values shown in Table 2. The maximum temperature difference and the maximum blow velocity difference of hot air, which were obtained in the same manner as in Example 1, were as shown in Table 2. The evaluation results of the retardation film were as shown in Table 3.

The resultant retardation film had an in-plane phase difference R₀ of 60 nm, a thickness-direction phase difference Rₜₕ of 100 nm, an in-plane phase difference variation (ΔR₀) of 13 nm and an angle of optical axis of −4.1 to +4.4°. From these results, it was found that the retardation film is excellent in optical homogeneity in both phase difference and optical axis.

### Comparative Examples 7 and 8

A retardation film was prepared and evaluated in the same manner as in Example 2 except that, in the transverse stretching by a tenter method, the blow velocity and blow amount of hot air in each zone were set to the numerical values shown in Table 2. The maximum temperature difference and maximum blow velocity difference of hot air, which were obtained in the same manner as in Example 1, were as shown in Table 2. The evaluation results of the retardation film were as shown in Table 3.

The retardation film prepared in Comparative Example 7 had an in-plane phase difference R₀ of 90 nm, a thickness-direction phase difference Rₜₕ of 110 nm, an in-plane phase difference variation (ΔR₀) of 24 nm and an angle of optical axis of −1.1 to +0.9°. The uniformity of the optical axis was excellent; however, the uniformity of phase difference was low compared to that of Example 2.

The retardation film prepared in Comparative Example 8 had an in-plane phase difference R₀ of 45 nm, a thickness-direction phase difference Rₜₕ of 100 nm, an in-plane phase difference variation (ΔR₀) of 11 nm and an angle of optical axis of −6.7 to +6.2°. The uniformity of phase difference was excellent; however, the uniformity of the optical axis was low compared to that of Example 2.

### Example 3

A retardation film was prepared and evaluated in the same manner as in Example 1 except that, in the transverse stretching by a tenter method, as the hot-air blowout nozzle used in the stretching zone, the punching nozzle 38 used in the preheating zone of Example 1 was used (Table 1) and the blow velocity and blow amount of hot air in each zone were set to the numerical values shown in Table 2. The maximum temperature difference and maximum blow velocity difference of hot air, which were obtained in the same manner as in Example 1, were as shown in Table 2. The evaluation results of the retardation film were as shown in Table 3.

The resultant retardation film had an in-plane phase difference R₀ of 60 nm, a thickness-direction phase difference Rₜₕ of 105 nm, an in-plane phase difference variation (ΔR₀) of 13 nm and an angle of optical axis of −3.2 to +3.1°. From these results, it was found that the retardation film is excellent in optical homogeneity in both phase difference and optical axis.

### Comparative Examples 9 and 10

A retardation film was prepared and evaluated in the same manner as in Example 3 except that, in the transverse stretching by a tenter method, the blow velocity and blow amount of hot air in each zone were set to the numerical values shown in Table 2. The maximum temperature difference and the maximum blow velocity difference of hot air, which were obtained in the same manner as in Example 1, were as shown in Table 2. The evaluation results of the retardation film were as shown in Table 3.

The retardation film prepared in Comparative Example 9 had an in-plane phase difference R₀ of 90 nm, a thickness-direction phase difference Rₜₕ of 115 nm, an in-plane phase difference variation (ΔR₀) of 23 nm and an angle of optical axis of −3.3 to −0.2°. The uniformity of the optical axis was excellent; however, the uniformity of phase difference was low compared to that of Example 3.

The retardation film prepared in Comparative Example 10 had an in-plane phase difference R₀ of 50 nm, a thickness-direction phase difference Rₜₕ of 95 nm, an in-plane phase difference variation (ΔR₀) of 7 nm and an angle of optical axis of −6.6 to +5.3°. The uniformity of phase difference was excellent; however, the uniformity of the optical axis was low compared to that of Example 3.

### Example 4

A retardation film was prepared and evaluated in the same manner as in Example 1 except that, in the transverse stretching by a tenter method, as the hot-air blowout nozzle in the preheating zone and heat setting zone, the punching nozzle 38 having circular openings 44 of 7 mm in diameter was used and the blow velocity and blow amount of hot air in each zone were set to the numerical values shown in Table 2. The total area of the openings 44 of each punching nozzle 38 provided in the preheating zone and heat setting zone, in short, the area of the blowout port, was 0.018 m² and the area of the blowout port per meter of the length of the nozzle along the film-width direction was 0.0162 m².

The maximum temperature difference and maximum blow velocity difference of hot air obtained in the same manner as in Example 1 were as shown in Table 2. The evaluation results of the retardation film were as shown in Table 3.

The resultant retardation film had an in-plane phase difference R₀ of 70 nm, a thickness-direction phase difference Rₜₕ of 85 nm, an in-plane phase difference variation (ΔR₀) of 11 nm and an angle of optical axis of −2.0 to −0.8°. From these results, it was found that the retardation film is excellent in optical homogeneity in both phase difference and optical axis.

### Comparative Examples 11 and 12

A retardation film was prepared and evaluated in the same manner as in Example 4 except that, in the transverse stretching by a tenter method, the air blow velocity and air blow amount in each zone were set to the numerical values shown in Table 2. The maximum temperature difference and the maximum blow velocity difference of hot air, which were obtained in the same manner as in Example 1, were as shown in Table 2. The evaluation results of the retardation film were as shown in Table 3.

The retardation film prepared in Comparative Example 11 had an in-plane phase difference R₀ of 110 nm, a thickness-direction phase difference Rₜₕ of 90 nm, an in-plane phase difference variation (ΔR₀) of 25 nm and an angle of optical axis of +0.6 to +1.8°. The uniformity of the optical axis was excellent; however, the uniformity of phase difference was low compared to that of Example 4.

The retardation film prepared in Comparative Example 12 had an in-plane phase difference R₀ of 45 nm, a thickness-direction phase difference Rₜₕ of 80 nm, an in-plane phase difference variation (ΔR₀) of 13 nm and an angle of optical axis of −6.0 to +5.1°. The uniformity of phase difference was excellent; however, the uniformity of the optical axis was low compared to that of Example 4.

TABLE 1

| | Preheating zone | Stretching zone | Heat setting zone |
|---|---|---|---|
| Example 1 | Punching nozzle | Jet nozzle | Punching nozzle |
| Comparative Example 1 | Jet nozzle | Jet nozzle | Jet nozzle |
| Comparative Example 2 | Jet nozzle | Jet nozzle | Jet nozzle |
| Comparative Example 3 | Jet nozzle | Jet nozzle | Jet nozzle |
| Comparative Example 4 | Jet nozzle | Jet nozzle | Jet nozzle |
| Comparative Example 5 | Punching nozzle | Jet nozzle | Punching nozzle |
| Comparative Example 6 | Punching nozzle | Jet nozzle | Punching nozzle |
| Example 2 | Punching nozzle | Jet nozzle | Jet nozzle |
| Comparative Example 7 | Punching nozzle | Jet nozzle | Jet nozzle |
| Comparative Example 8 | Punching nozzle | Jet nozzle | Jet nozzle |
| Example 3 | Punching nozzle | Punching nozzle | Punching nozzle |
| Comparative Example 9 | Punching nozzle | Punching nozzle | Punching nozzle |
| Comparative Example 10 | Punching nozzle | Punching nozzle | Punching nozzle |
| Example 4 | Punching nozzle | Jet nozzle | Punching nozzle |
| Comparative Example 11 | Punching nozzle | Jet nozzle | Punching nozzle |
| Comparative Example 12 | Punching nozzle | Jet nozzle | Punching nozzle |

TABLE 2

| | | | | | | | | | | Maximum blow | Maximum |
|---|---|---|---|---|---|---|---|---|---|---|---|
| | Area of blowout port | | | Air blow velocity | | | Air blow amount | | | velocity | temperature |
| | (note 1) (m²) | | | (m/s) | | | (note 2) (m³/s) | | | difference | difference ° C. |
| | | | Heat | | | Heat | | | Heat | m/s (note 3) | (note 4) |
| Zone | Preheating | Stretching | setting | Preheating | Stretching | setting | Preheating | Stretching | setting | — | — |
| Example 1 | 0.011 | 0.005 | 0.011 | 11 | 15 | 11 | 0.121 | 0.075 | 0.121 | 0.7 | 1.0 |
| Comparative | 0.005 | 0.005 | 0.005 | 15 | 15 | 15 | 0.075 | 0.075 | 0.075 | 0.8 | 1.0 |
| Example 1 | | | | | | | | | | | |
| Comparative | 0.005 | 0.005 | 0.005 | 8 | 8 | 8 | 0.040 | 0.040 | 0.040 | 0.5 | 1.0 |
| Example 2 | | | | | | | | | | | |
| Comparative | 0.005 | 0.005 | 0.005 | 20 | 20 | 20 | 0.100 | 0.100 | 0.100 | 1.0 | 1.0 |
| Example 3 | | | | | | | | | | | |
| Comparative | 0.005 | 0.005 | 0.005 | 20 | 20 | 20 | 0.100 | 0.100 | 0.100 | 1.0 | 1.0 |
| Example 4 | | | | | | | | | | | |
| Comparative | 0.011 | 0.005 | 0.011 | 6 | 8 | 6 | 0.066 | 0.040 | 0.066 | 0.3 | 1.0 |
| Example 5 | | | | | | | | | | | |
| Comparative | 0.011 | 0.005 | 0.011 | 17 | 20 | 17 | 0.187 | 0.100 | 0.187 | 0.9 | 1.0 |
| Example 6 | | | | | | | | | | | |
| Example 2 | 0.011 | 0.005 | 0.005 | 11 | 15 | 15 | 0.121 | 0.075 | 0.075 | 0.7 | 1.0 |
| Comparative | 0.011 | 0.005 | 0.005 | 6 | 8 | 8 | 0.066 | 0.040 | 0.040 | 0.3 | 1.0 |
| Example 7 | | | | | | | | | | | |
| Comparative | 0.011 | 0.005 | 0.005 | 17 | 20 | 20 | 0.187 | 0.100 | 0.100 | 0.9 | 1.0 |
| Example 8 | | | | | | | | | | | |
| Example 3 | 0.011 | 0.011 | 0.011 | 11 | 11 | 11 | 0.121 | 0.121 | 0.121 | 0.7 | 1.0 |
| Comparative | 0.011 | 0.011 | 0.011 | 6 | 6 | 6 | 0.066 | 0.066 | 0.066 | 0.3 | 1.0 |
| Example 9 | | | | | | | | | | | |
| Comparative | 0.011 | 0.011 | 0.011 | 17 | 17 | 17 | 0.187 | 0.187 | 0.187 | 0.9 | 1.0 |
| Example 10 | | | | | | | | | | | |
| Example 4 | 0.018 | 0.005 | 0.018 | 9 | 15 | 9 | 0.162 | 0.075 | 0.162 | 0.7 | 1.0 |
| Comparative | 0.018 | 0.005 | 0.018 | 3 | 8 | 3 | 0.054 | 0.040 | 0.054 | 0.3 | 1.0 |
| Example 11 | | | | | | | | | | | |
| Comparative | 0.018 | 0.005 | 0.018 | 14 | 20 | 14 | 0.252 | 0.100 | 0.252 | 0.8 | 1.0 |
| Example 12 | | | | | | | | | | | |

(note 1):
the area of the blowout port per meter of the length of each nozzle along the film-width direction
(note 2):
the air blow amount per meter of the length along the film-width direction at a blowout port of each nozzle
(note 3):
the maximum value of the difference between a maximum blow velocity and a minimum blow velocity of hot air at a blowout port of each nozzle
(note 4):
the maximum value of the difference between a maximum temperature and a minimum temperature of hot air in the width direction of each nozzle

TABLE 3

| | Rₒ | Rₜₕ | ΔRₒ | | Angle of optical axis | |
|---|---|---|---|---|---|---|
| | (nm) | (nm) | (nm) | Evaluation | (°) | Evaluation |
| Example 1 | 50 | 90 | 10 | A | −4.1 to +3.0 | A |
| Comparative | 80 | 100 | 35 | B | −3.1 to +7.7 | B |
| Example 1 | | | | | | |
| Comparative | 100 | 80 | 57 | B | −1.1 to +2.0 | A |
| Example 2 | | | | | | |
| Comparative | 50 | 105 | 27 | B | −5.8 to +9.5 | B |
| Example 3 | | | | | | |
| Comparative | 50 | 95 | 28 | B | −5.6 to +6.9 | B |
| Example 4 | | | | | | |
| Comparative | 80 | 90 | 39 | B | −2.7 to −1.1 | A |
| Example 5 | | | | | | |
| Comparative | 50 | 95 | 6 | A | −7.4 to +9.1 | B |
| Example 6 | | | | | | |
| Example 2 | 60 | 100 | 13 | A | −4.1 to +4.4 | A |
| Comparative | 90 | 110 | 24 | B | −1.1 to +0.9 | A |
| Example 7 | | | | | | |
| Comparative | 45 | 100 | 11 | A | −6.7 to +6.2 | B |
| Example 8 | | | | | | |
| Example 3 | 60 | 105 | 13 | A | −3.2 to +3.1 | A |
| Comparative | 90 | 115 | 23 | B | −3.3 to −0.2 | A |
| Example 9 | | | | | | |
| Comparative | 50 | 95 | 7 | A | −6.6 to +5.3 | B |
| Example 10 | | | | | | |
| Example 4 | 70 | 85 | 11 | A | −2.0 to −0.8 | A |
| Comparative | 110 | 90 | 25 | B | +0.6 to +1.8 | A |
| Example 11 | | | | | | |
| Comparative | 45 | 80 | 13 | A | −6.0 to +5.1 | B |
| Example 12 | | | | | | |

### INDUSTRIAL APPLICABILITY

According to the method for producing a retardation film of the present invention, it is possible to provide a method for producing a retardation film of a thermoplastic resin having sufficiently uniform phase difference and sufficiently high axis accuracy.

1. A method for producing a retardation film by a tenter method, comprising:
a preheating step of heating a thermoplastic resin film with hot air;
a stretching step of stretching the preheated thermoplastic resin film in the width direction while heating the film with hot air to obtain a stretched film; and
a heat setting step of heating the stretched film with hot air,
wherein, the heating of a film in at least one step selected from the group consisting of the preheating step, the stretching step and the heat setting step is performed by spraying hot air supplied from blowout ports of a pair of nozzles facing each other to both surfaces of the film;
an air blow velocity at the blowout port is 2 to 12 m/second, an air low amount from the blowout port per nozzle is 0.1 to 1 m³/second per meter of the length of the nozzle along the width direction of the film.

2. The method for producing a retardation film according to claim 1, wherein the nozzle is a jet nozzle having a slit-form blowout port extending in the width direction of the film or a punching nozzle having a blowout port having a plurality of openings arranged in the longitudinal direction of the film and in the width direction of the film.

3. The method for producing a retardation film according to claim 1, wherein the nozzle is a jet nozzle having a slit-form blowout port extending in the width direction of the film and the slit width of the jet nozzle is 5 mm or more.

4. The method for producing a retardation film according to claim 1, wherein, in at least one step selected from the group consisting of the preheating step, the stretching step and the heat setting step, the difference between the maximum temperature and the minimum temperature of the hot air in the width direction of the film at a blowout port of each of the nozzles for spraying hot air to the film is 2° C. or less.

5. The method for producing a retardation film according to claim 1, wherein in at least one step selected from the group consisting of the preheating step, the stretching step and the heat setting step, the difference between the maximum blow velocity and the minimum blow velocity of the hot air in the width direction of the film at the blowout port of each of the nozzles for spraying hot air to the film is 4 m/s or less.

6. The method for producing a retardation film according to claim 1, wherein all of the preheating step, the stretching step and the heat setting step are performed in an oven having a cleanliness factor of an air cleanliness class of 1000 or less.

7. The method for producing a retardation film according to claim 1, wherein the thermoplastic resin is a crystalline polyolefin based resin.

8. The method for producing a retardation film according to claim 7, wherein the crystalline polyolefin based resin is a polypropylene based resin.
